(19) United States
(12) Patent Application Publication
(10) Pub. No.: US 2018/0232053 A1
(43) Pub. Date: Aug. 16, 2018

(54) CONTROL DEVICE

(71) Applicant: DENSO TEN Limited, Kobe-shi (JP)

(72) Inventor: Atsushi HAMABATA, Kobe-shi (JP)

(73) Assignee: DENSO TEN Limited, Kobe-shi (JP)

(21) Appl. No.: 15/880,941

(22) Filed: Jan. 26, 2018

(30) Foreign Application Priority Data
Feb. 15, 2017 (JP) 2017-025815

(51) Int. Cl. G06F 3/01; G06F 3/0484; G06T 15/00; G06F 3/041

(52) U.S. Cl. CPC G06F 3/016; G06F 3/04847; G06F 2203/013; G06F 3/041; G06T 15/00

(57) ABSTRACT

A control device controls a display having a touch screen. The control device includes a detector that detects touch on the touch screen, and a vibration controller that generates vibration of the touch screen according to the detected touch. The vibration controller of the control device changes the vibration according to a position of the detected touch and a movement direction of a sliding operation of the touch on the touch screen.

### BACKGROUND OF THE INVENTION

### Field of the Invention

The present invention relates a control device and a control method.

### Description of the Background Art

In the related art, an input device such as a touchpad or a touch panel has been known. The input device (hereinafter, also referred to as a “touch device”) such as the touchpad or the touch panel detects a touch position of the finger of an operator (hereinafter, also referred to as a “user”) that touches a device surface through a sensor device. For example, the touch device functions as a pointing device that operates a graphical user interface (GUI) component displayed on a display device such as a liquid crystal display (LCD).

In recent years, a technology for applying a predetermined tactile sensation to an operation finger of a user that touches a front surface of the touch device by vibrating the front surface has been suggested. For example, in the technology for applying the tactile sensation, a tactile sensation (rough sensation) with fine irregularities as if the user traces on the sand may be applied to or a smooth tactile sensation (smooth sensation) may be applied to the fingertip that touches the front surface of the touch device according to the magnitude of a vibration frequency. In a control device of the touch device, an operational sensation in a case where the GUI component (a pointer or a switch) displayed on the display device is operated may be applied to the user through the vibration of the touch device surface by using the technology for applying the tactile sensation.

However, in the technology of the related art, the tactile sensation applied to the operation finger of the user that operates the touch device is limited to two kinds of tactile sensations of a rough sensation or a smooth sensation.

### SUMMARY OF THE INVENTION

According to an aspect of the present invention, a control device that controls a display having a touch screen includes a detector that detects a touch on the touch screen, and a vibration controller that generates vibration of the touch screen according to the detected touch. The vibration controller changes the vibration according to a position of the detected touch and a movement direction of a sliding operation of the touch on the touch screen.

In a case where the sliding operation is performed, it is possible to provide a tactile sensation as if a touch position is drawn into a target displayed on a display image.

According to another aspect of the present invention, the vibration controller performs vibration change control for changing a degree of modulation of the vibration to a second state different from a first state according to a movement direction of the sliding operation.

In a case where the sliding operation is performed, it is possible to provide a tactile sensation corresponding to characteristics of an image content displayed on a display device.

An object of the present invention is to provide various tactile sensations according to image contents displayed on a display device in a case where a sliding operation is performed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of a configuration of a control system.

FIG. 2 is a diagram showing an example of a state in which the control system is mounted on a vehicle.

FIG. 3 is an explanatory diagram for describing a change in modulation amount of amplitude modulation according to the present embodiment.

FIG. 4 is a diagram showing an example of a hardware configuration of a control device.

FIG. 5 is an example of a display image in a case where tactile sensation control according to the present embodiment is performed.

FIG. 6 is a diagram for describing the tactile sensation control based on information indicated by the display image.

FIG. 7 is an example of another display image in a case where the tactile sensation control according to the present embodiment is performed.

FIG. 8 is a diagram for describing the tactile sensation control in a case where a plurality of targets is present.

FIG. 9 is a flowchart showing an example of a tactile sensation control process provided by the control device.

FIG. 10 is an example of a display image in a case where tactile sensation control according to a modification example is performed.

### DESCRIPTION OF THE INVENTION

Hereinafter, a control device according to an embodiment will be described with reference to the drawings. The configuration of the following embodiment is merely an example, and the configuration of the present control device is not limited to the configuration of the embodiment.

### 1. System Configuration

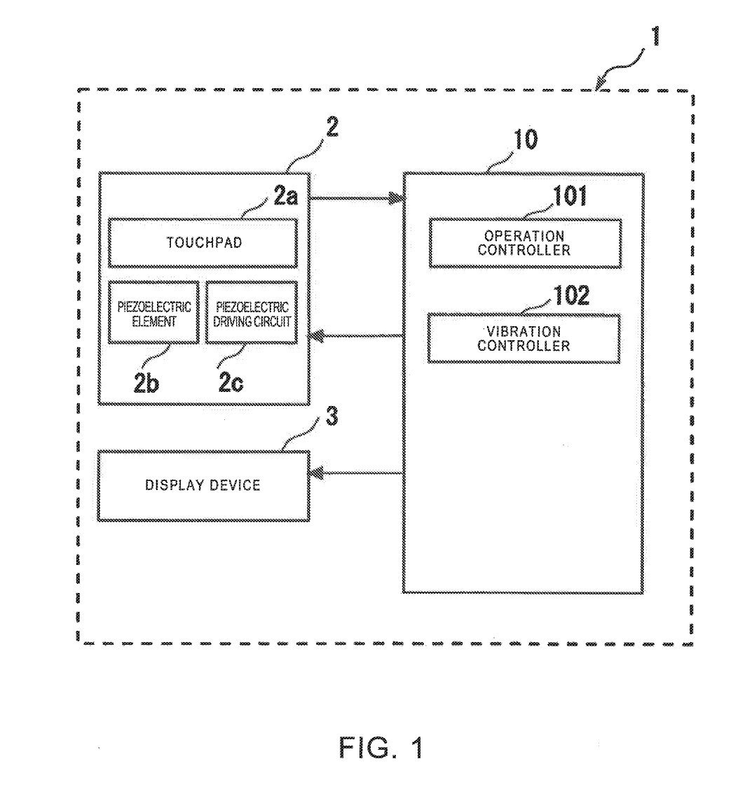

FIG. 1 is a diagram showing an example of a configuration of a control system according to the present embodiment. For example, a control system 1 shown in FIG. 1 is applied to a vehicular audio visual navigation integrated machine (hereinafter, also referred to as AVN) mounted on a vehicle. The control system 1 includes a touch device 2, a display device 3, and a control device 10, and constitutes a part of the AVN machine. The touch device 2 and the display device 3 of the control system 1 connected to the control device 10. For example, the touch device 2 functions as a pointing device for indicating a display position of a GUI component displayed on the display device 3 such as an LCD.

Hereinafter, the embodiment illustrated in FIG. 1 is an explanatory example of the control system 1 according to the present embodiment. However, as long as an embodiment including the touch device 2 is used, the control system 1 may constitute a part of an information processing apparatus such as a smartphone, a personal computer (PC), a laptop, or a tablet PC. The control system 1 may be a game machine or a wearable device capable of being worn on the body such as the head or arm of a user.

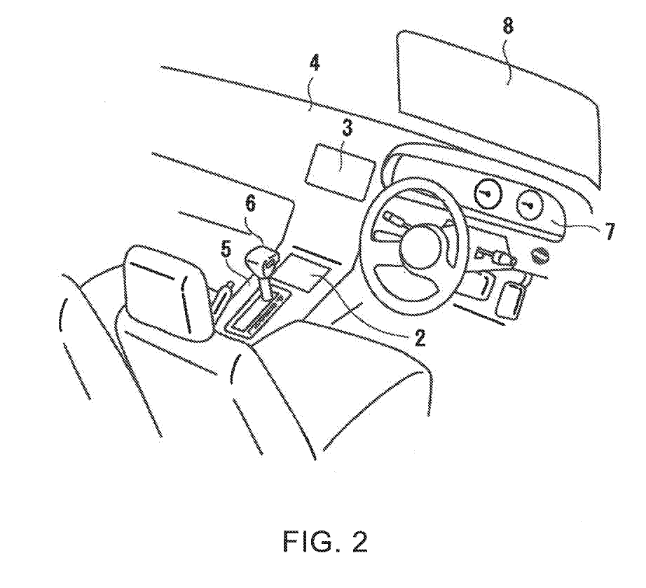

FIG. 2 is a diagram showing an example of a state in which the control system 1 is mounted on the vehicle. As shown in FIG. 2, the display device 3 constituting the part of the AVN machine is provided on a substantially center of a dashboard 4 of the vehicle on which the display device is to be mounted. Similarly, the touch device 2 is provided a center console 5 in which a shift lever 6 is provided. For example, the touch device 2 is provided in froth of the shift lever 6 so as to expose a device surface. A position of the touch device 2 in the center console 5 may be provided behind the shift lever 6.

For example, various contents such as navigation imps or television (TV) broadcasts provided through the AVN machine and reproduction images reproduced in digital versatile disk (DVD) or Blu-ray (BD (registered trademark)) disc are displayed on the display device 3. The various contents displayed on the display device 3 include a GUI component for selecting or determining a desired functional item for a display content.

For example, the GUI component displayed on the display device 3 is indicated by a pointer such as a cursor that moves in a display area in line with a touch position detected through the touch device 2. The control system 1 specifies a GUI component as an operation target based on a touch operation of the user received through the touch device 2, and performs a processing function associated with the GUI component. For example, in a case where the GUI component as the operation target is a button component or a switch component, a display screen is switched or a content capable of being viewed is reproduced in response to the touch operation. In a case where the GUI component as the operation target is a slide bar using an increase or a decrease in volume for the content being viewed as a control target, a control amount of the volume increases or decreases according to a movement amount of the slide bar. Screen scrolling or zooming in or out of the display screen displayed on the display device 3 is performed based on the touch operation of the user receives through the touch device 2.

In the control system 1 shown in FIG. 2, the display device 3 may constitute a meter panel 7 on which a speedometer and a tachometer are displayed or may constitute a head-up display 8 on which the display content is projected on an inner surface of a windshield of the vehicle. In the control system 1, the GUI component displayed on the display device 3 constituting the meter panel 7 or the head-up display 8 can be operated through the touch device 2.

The display device 3 may be a touch panel combined by overlapping an LCD on which various contents are displayed with a sensor device that detects coordinates of a touch position of an operation finger which touches on a front surface of the LCD. The display device 3 functions as the touch panel, and thus, the control system 1 can provide the display device 3 and the touch device 2, as a single unit.

The control system 1 may operate the touch device 2 and the display device 3 functioning as the touch panel, as separate units. For example, an occupant seated on a front passenger seat may perform a touch operation by using the display device 3 provided on the dashboard 4 as a target, and an occupant seated on a driver seat may perform a touch operation by using the touch device 2 provided on the center console 5 as a target.

Referring back to FIG. 1, the touch device 2 includes a touchpad 2a, a piezoelectric element 2b, and a piezoelectric driving circuit 2c. The touchpad 2a is an input device that detects coordinates of a touch position of the user's finger which touches a device surface. For example, the touch position of the finger which touches on the device surface of the touchpad 2a may be expressed by two-dimensional coordinates (X, Y) which use an upper left corner of the touchpad 2a as an origin and use a right-left direction as an X-axis and an upper-lower direction as a Y-axis. The coordinates of the touch position detected through the touchpad 2a are associated with the display area of the display device 3 in one-to-one correspondence. For example, the coordinates of the touch position detected through the touchpad 2a are input to the control device 10 at predetermined periodic intervals of 10 ms. The device surface of the touchpad 2a on which the touch of the user is detected is also referred to as a “front surface”.

The touch position detected on the touchpad 2a may be relative coordinates associated with the display area of the display device 3. For example, in a case where the touch position is the relative coordinates, the touch position of the user's finger which touches the front surface of the touchpad 2a is a cursor position displayed in the display area of the display device 3. In the display device 3, the cursor moves in the display area according to an operation amount of a sliding operation detected through the touchpad 2a. In a case where the cursor position is superimposed on an operation target item (GUI component) displayed on the display device 3, a function (application program function) associated with a target item is executed by a touch operation such as double-touch, press, or long-press.

The piezoelectric element 2b is a piezoelectric element which changes so as to expand or contract according to an applied voltage. For example, the piezoelectric element 2b is disposed while touching a rear surface (a surface opposite to the device surface on which the touch of the user is detected) of the touchpad 2a. A plurality of piezoelectric elements 2b may be arranged.

The piezoelectric driving circuit 2c is a circuit that generates a voltage to be applied to the piezoelectric element 2b. The piezoelectric driving circuit 2c generates a voltage to be applied to the piezoelectric element 2b at predetermined periodic intervals based on a driving instruction from the control device 10. The plurality of piezoelectric elements 2b may be connected to the piezoelectric driving circuit 2c.

In general, a fingertip is detected using a vibration frequency that vibrates in a frequency of about 0 Hz to 300 Hz, as a tactile sensation. For example, in the touch device 2, the piezoelectric element 2b disposed while touching the rear surface of the touchpad 2a vibrates based on a voltage value applied from the piezoelectric driving circuit 2c, and thus, a tactile sensation may be applied to the finger of the user which touches the front surface (device surface). For example, the control device 10 may apply the tactile sensation to the user's finger which touches the front surface by performing amplitude modulation sing the vibration frequency in a state in which the front surface of the touch device 2 resonates.

For example, the control device 10 may apply a tactile sensation (rough sensation) with fine irregularities as if the user traces on the sand by performing control (amplitude modulation) such that the voltage value to be applied to the piezoelectric element 2b vibrates in a frequency of about 50 Hz through the piezoelectric driving circuit 2c. For example, the control device 10 may apply a smoother tactile sensation like the smooth sensation to the fingertip by performing control such that the voltage value to be applied to the piezoelectric element 2b vibrates in a frequency of about 300 Hz through the piezoelectric driving circuit c.

### Tactile Sensation Control According to Present Invention

In the control system 1 according to the present embodiment, in a case where the touch operation on the touch device 2 is a movement operation, the control device 10 changes a modulation amount of the amplitude modulation for vibrating the device surface according to a movement direction using the touch position as a start point. In this example, the “movement operation” is, for example, a sliding operation or a flicking operation in which the operation finger which touches the device surface (front surface) of the touch device 2 moves the touch position while sliding on the device surface in a state in which the finger is touching the device surface.

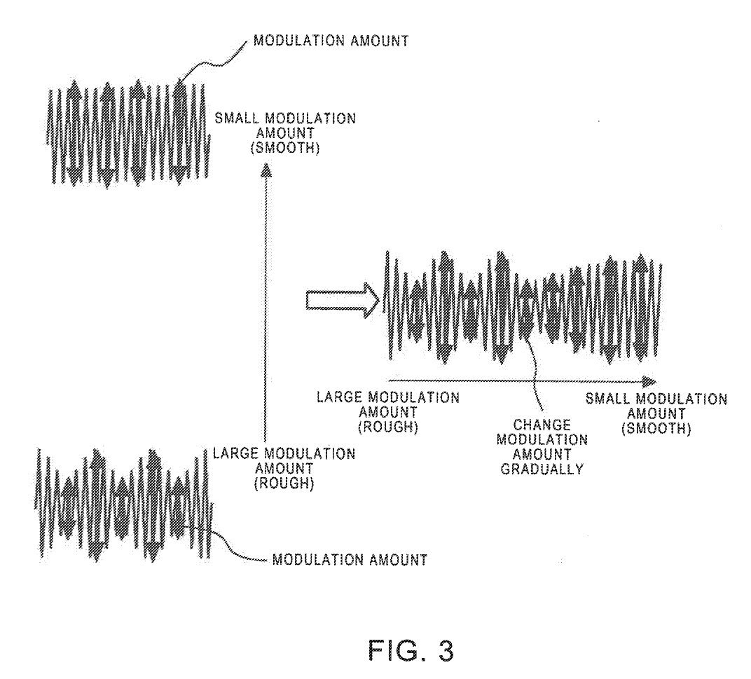

FIG. 3 is an explanatory diagram for describing a change in modulation amount of the amplitude modulation according to the present embodiment. In the control system 1 according to the present embodiment, the modulation amount of the amplitude modulation for applying the tactile sensation is continuously changed according to the movement direction in a case where the sliding operation is performed, as shown in FIG. 3.

For example, in a case where the movement direction moves in a predetermined direction by using touch position as the start point, the control device 10 performs control such that the modulation amount of the amplitude modulation increases. A tactile sensation changed such that the tactile sensation at the start point further increases the rough sensation may be applied to the fingertip which touches the device surface of the touch device 2. Similarly, for example, in a case where the movement direction moves in a direction opposite to the predetermined direction by using the touch position as the start point, the control device 10 performs control such that the modulation amount of the amplitude modulation decreases. A tactile sensation changed such that the tactile sensation at the start point further increases the smooth sensation may be applied to the fingertip which touches the device surface of the touch device 2.

For example, if a modulation amount in a case where a tactile sensation with low resistance like the smooth sensation is applied as the modulation amount of the amplitude modulation for applying the tactile sensation is V0, a modulation amount V1 in a case where a tactile sensation with high resistance like the rough sensation is applied may be expressed by a relative modulation amount with respect to the modulation amount V0 which ranges from 10 to 100 percentages.

For example, in the control system 1 according to the present embodiment, a degree of change in the modulation amount in the movement direction (operation direction) from a start position may be changed according to an information content displayed on the display device 3.

For example, it is assumed that terrain such as beaches or mountains along passage routes or map information related to the navigation provided from the AVN machine is displayed in the display area of the display device 3 provided in the substantially center of the dashboard 4 shown in FIG. 2. For example, the control device 10 changes the degree of change in modulation amount of the amplitude modulation applied as the tactile sensation according to the type (a mountain area, a beach area, or a flat area) of a map area or the height of the terrain which is present at a destination of the movement direction, which is displayed on the display device 3.

For example, in a case where the movement operation is performed in a direction in which the elevation increases from a touch start position, the control device 10 increases the modulation amount of the amplitude modulation, and changes the tactile sensation applied to the fingertip which is touching the device surface of the touch device 2 so as to further increase the rough sensation. For example, in a case where the movement operation is performed in a direction in which the elevation decreases from the touch start position, the control device 10 decreases the modulation amount of the amplitude modulation, and changes the tactile sensation applied to the fingertip which touches the device surface of the touch device 2 so as to further increase the smooth sensation. Characteristics indicated by an image content indicating a change in height of the terrain displayed on the display device 3 may be applied through the tactile sensation. The control device 10 may allow the user who performs a blind operation on the touch device 2 provided in the center console 5 to recognize the change in height of the terrain through the tactile sensation. In the control system 1 according to the present embodiment, the control device 10 may perform control such that the tactile sensation is applied to the user's finger by using a two-dimensional touch area of the touch device 2.

### 2. Configuration of Control Device

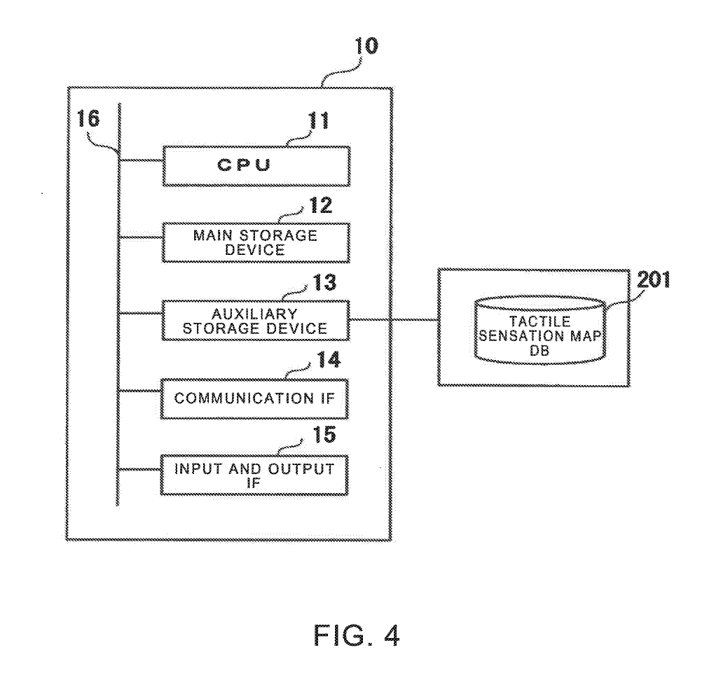

FIG. 4 is a diagram showing an example of a hardware configuration of the control device 10 according to the present embodiment. As shown in FIG. 4, the control device 10 is a computer including a central processing unit (CPU) 11, a main storage device 12, an auxiliary storage device 13, a communication interface (IF) 14, and an input and output IF 15 which are connected to each other through a connection bus 16.

The CPU 11 is also referred to as a microprocessor (MPU) or a processor. However, the CPU 11 is not limited to a single processor, and may be a multi-processor. A single CPU connected through a single socket may be a multi-core processor. The CPU 11 is a central processing unit that controls the entire control device 10. For example, the CPU 11 develops a program stored in the auxiliary storage device 13 in a work area of the main storage device 12 so as to execute the program, and provides a function matching a predetermined purpose by controlling a peripheral device by executing the program.

The main storage device 12 is a storage medium in which the CPU 11 caches a program or data or develops a work area. For example, the main storage device 12 includes a flash memory, a random access memory (RAM), or a read only memory (ROM). The auxiliary storage device 13 is a storage medium that stores a program to be executed by the CPU 11 or operation setting information. Examples of the auxiliary storage device 13 include a hard-disk drive (HDD), a solid state drive (SSD), an erasable programmable ROM (EPROM), a flash memory, a USB memory, or a Secure Digital (SD) memory card. The communication IF 14 is an interface of a network connected to the control device 10. The network connected to the control device 10 includes a controller area network (CAN) or a local interconnect network (LIN). The input and output IF 15 is an interface that performs the input and output of data to and from a sensor or a device connected to the control device 10. In the control system 1, the input and output of the data to and from the touch device 2 and the display device 3 are controlled through the input and output IF 15. The constituent elements may be provided in plural or some of the constituent elements may not be provided. The constituent elements may be included in the constituent element of the AVN machine.

In the control device 10, at least processors of an operation controller 101 and a vibration controller 102 shown in FIG. 1 are provided by executing the program of the CPU 11. However, at least some processes of the processors may be provided by a digital signal processor (DSP) or an application specific integrated circuit (ASIC). At least some of the processors may be dedicated large scale integration (LSI) such as a field-programmable gate array (FPGA) or other digital circuits. Art analog circuit may be included in at least some of the processors. In the control device 10, a tactile sensation MAP DB 201 is included in the auxiliary storage device 13 as a storage destination of data to be referred or aged by the processors.

The operation controller 101 receives the coordinates of the touch position of the operation finger detected through the touch device 2. For example, the operation controller 101 receives the coordinates of the touch position at predetermined periodic intervals of 10 ms. The operation controller 101 temporarily stores the coordinates of the touch position in a predetermined area of the main storage device 12. A coordinate change of the touch position received at predetermined periodic intervals is a time-series trajectory corresponding to the movement operation of the fingertip which moves on the touch device 2. The operation controller 101 delivers an acquired coordinate position of the touch position to the vibration controller 102.

The vibration controller 102 specifies the movement operation (the sliding operation or the flicking operation) of the fingertip which moves on the front surface (device surface) of the touch device 2 while sliding on the front surface in a state in which the finger is touching the front surface or the movement direction corresponding to the movement operation from the coordinate change of the touch position acquired at predetermined periodic intervals.

The vibration controller 102 acquires display information (display image) displayed on the display device 3 in a case where the movement operation performed. At least drawing information associated with the display area of the display device 3, an identification number for identifying the display information, and information regarding the contents and the characteristics indicated by the display information are included in the display information. For example, the display information is acquired by the AVN machine.

The vibration controller 102 refers to the tactile sensation MAP DB 201, and acquires a modulation pattern for applying the tactile sensation corresponding to the display information. For example, the tactile sensation MAP DB 201 stores the degree of change (modulation pattern) of the modulation amount of the amplitude modulation associated with the identification number for identifying the display information. The vibration controller 102 perform the tactile sensation control on the touch device 2 corresponding to the contents and the characteristics indicated by the display information based on the display information displayed on the display device 3 and the modulation pattern of the amplitude modulation associated with the display information. The tactile sensation control on the touch device 2 is performed as an output of a driving signal (driving instruction) based on the modulation pattern for the piezoelectric driving circuit 2c. The piezoelectric driving circuit 2c changes the modulation amount of the amplitude modulation of the touch device 2 in a resonance state based on the driving signal from the control device 10.

### 3. Tactile Sensation Control

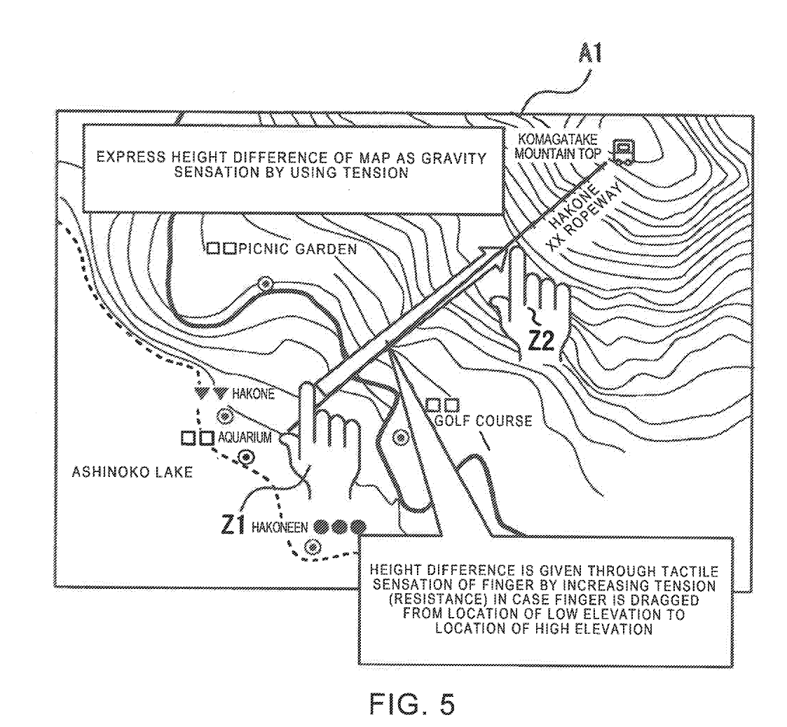

Hereinafter, the tactile sensation control for the touch device 2 according to the present embodiment will be described with reference to FIGS. 5 to 8.

### Control Example 1

FIG. 5 is an example of a display image in a case where the tactile sensation control according to the present embodiment is performed. For example, a display image A1 of FIG. 5 is a navigation image displayed on the display device 3 as a content to be provided from the AVN machine mounted on the vehicle. A pointer Z1 or Z2 indicates an icon that moves on the display image A1 in line with the coordinates of the operation finger which touches the device surface of the touch device 2.

As shown in FIG. 5, a destination or a map image on a route to the destination is displayed on the display image A1. A form such as the height or undulation of the ground surface represented at a predetermined scale is displayed on the display image A1 together with contour lines. The type (a mountain area, a beach area, a flat area, or an urban area) of the terrain area, the boundary of the sea or the lake, and the shape of a river is displayed on the display image A1. The height or undulation of the ground surface, the counter lines, the type (a mountain area, a beach area, a flat area, or an urban area) of the terrain area, the boundary of the sea or the lake, and the shape of the river on the display image A1 represent the contents and characteristics indicated by the display information.

For example, it is assumed that the user seated on the driver's seat performs the touch operation (sliding operation) on the touch device 2 provided at the center console 5 in a state in which the display image A1 shown in FIG. 5 is displayed on the display device 3 provided at the dashboard 4 or on the head-up display 8. It is assumed that the user touches the device surface of the touch device 2 with their fingertip and moves the icon displayed so as to be superimposed on the display image A1 to the pointer Z2 from the pointer Z1 through the blind operation.

The control device 10 acquires the display information (the contents and characteristics indicated by the display information, the identification number of the display information, or the drawing information associated with the display area) for the display image A1 through the AVN machine. The control device 10 refers to the tactile sensation MAP DB 201, and changes the tactile sensation applied to the fingertip of the user that moves on the device surface of the touch device 2 while sliding on the device surface based on the contents and characteristics indicated by the display image A1 displayed in the display area of the display device 3.

For example, the control device 10 changes the tactile sensation (the modulation amount of the amplitude modulation) applied to the fingertip of the user according to the elevation difference or gradient between the points on the display image A1 indicated by the pointers Z1 and Z2.

In the example of FIG. 5, for example, the control device 10 changes the modulation amount such that the tactile sensation with high resistance like the rough sensation is applied from the tactile sensation with low resistance like the smooth sensation based on the elevation difference on a movement route in the direction of the pointer Z2 from the elevation at the point indicated by the pointer Z1. In the example of FIG. 5, the control device 10 may increase tension (resistance) from the point having low elevation in a case where the sliding operation is performed from the point (pointer Z1) having low elevation on the display image A1 to the point (pointer Z2) having high elevation. The control device 10 may allow the user to recognize the form such as the height or undulation of the ground surface on the movement route in the sliding direction from the point on the display image A1 corresponding to the start position of the sliding operation through the tactile sensation.

The control device 10 may change the tactile sensation (the modulation amount of the amplitude modulation) applied to the fingertip of the user according to the type (a mountain area, a beach area (sandy beach or sea), a flat area, an urban area, lakes, or rivers) indicated by the terrain area displayed on the display image A1 on the movement route in the sliding direction.

For example, in a case where the sliding operation direction of the fingertip that touches the point of the mountain area on the display image A1 passes through flat area→urban area→mountain area, the control device 10 changes the modulation amount based on the tactile sensation which is allocated in advance to the type of the area through which the user passes. For example, it is assumed that modulation amounts Va, Vb, and Vc acquired by dividing the modulation amount into a plurality of levels are allocated to the mountain area, the flat area, and the urban area. It is assumed that the tactile sensations to which the modulation amounts are applied to the fingertip are changed such that the resistance decreases in order of the modulation amounts Va, Vb, and Vc (smooth sensations increase). For example, the control device 10 changes the tactile sensations applied to the fingertip of the user in order of modulation amount Va→modulation amount Vb→modulation amount Vc→modulation amount Va according to the type of the terrain area present in the sliding direction.

For example, the control device 10 may control such that a modulation amount per unit movement amount is ((modulation amount Vb)−(modulation amount Va)) during movement from the mountain area (modulation amount Va) to the flat area (modulation area Vb). In a case where the movement direction of the sliding operation is a direction from the mountain area to the flat area, since the modulation amount applied to the tactile sensation is changed such that the resistance decreases according to the movement distance, the tactile sensation as if the touch position is sucked into the flat area may be applied.

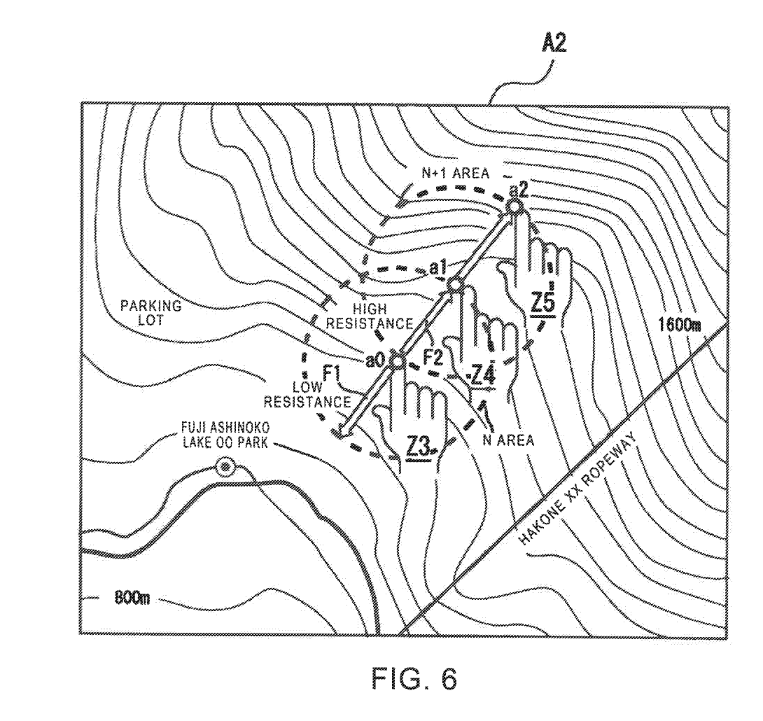

FIG. 6 is a diagram for describing the tactile sensation control based on information indicated by the display image. A display image A2 of FIG. 6 is an enlarged view of a route from the pointer Z1 to the pointer Z2 on the display image A1. Pointers Z3, Z4, and Z5 of FIG. 6 represent icons that move on. the display image A2 in line with the coordinates of the operator that touches the device surface of the touch device 2.

In FIG. 6, points of α0, α1, and α2 represent points on the movement route through the sliding operation. Circular areas N AREA and N+1 AREA represented by dashed lines represent a tactile sensation control range using the point α0 as a center and a tactile sensation control range using the point α1 as a center, respectively. In FIG. 6, the sizes of the circular areas (tactile sensation control ranges) in which the tactile sensation control is performed are the same. The point α1 is positioned at an edge of the circular area. N AREA using the point α0 as a center. The point α2 is positioned at an edge of the circular area N+1 AREA using the point α1 as a center. In the circular areas, the tactile sensation control for changing the modulation amount of the amplitude modulation is performed according to the elevation difference (height difference) between the points.

In FIG. 6, it is assumed that the point α0 indicated by the pointer Z1 is a start position of the sliding operation performed on the touch device 2. For example, the control device 10 extracts positional information (latitude, longitude, and elevation) of the point α0 from the display information acquired through the AVN machine. The control device 10 refers to the tactile sensation MAP DB 201, and acquires the modulation pattern associated with the display information. Control parameters such as a target content (elevation difference) for changing the modulation amount of the amplitude modulation, modulation amounts acquired by dividing the modulation amount into a plurality of levels, and a tactile sensation control range (circular area N AREA) are included in the modulation pattern. The control device 10 temporarily stores the extracted positional information of the point α0 in association with the modulation pattern acquired from the tactile sensation MAP DB 201 in the predetermined area of the main storage device 12.

The control device 10 specifies the mover lent direction corresponding to the sliding operation from a coordinate change of the touch position received at predetermined periodic intervals. For example, the movement direction corresponding to the sliding operation may be expressed by a relative angle (θ) with respect to an X-axis direction of the touch device 2. For example, the control device 10 may determine a sampling period in a case where the movement direction is detected in advance, and may acquire the movement direction (θ) corresponding to the sliding operation from a coordinate change (ΔY/ΔX) between a start position and an end position of the sampling period on the touch device 2.

The control device 10 specifies positional information of the point α1 present at the destination of the movement direction present at the edge of the circular area N AREA from the detected movement direction of the sliding operation and the tactile sensation control range using the point α0 as the center. The control device 10 acquires an elevation difference (ΔH) between the specified point α1 and the point α0.

For example, in a case where the elevation difference (ΔH) exceeds 0, the control device 10 increases the modulation amount according to the elevation difference, and performs the tactile sensation control for increasing the resistance (rough sensation) applied to the fingertip (direction of arrow F2). Meanwhile, for example, in a case where the elevation difference (ΔH) is less than 0, the control device 10 decreases the resistance applied to the fingertip by decreasing the modulation amount according to the elevation difference, and performs the tactile sensation control for applying the smooth sensation (direction of arrow F1). In a case where the elevation difference (ΔH) is less than 0, the control device 10 may set the modulation amount to be 0 irrespective of the elevation difference.

In a case where the modulation amounts at the point α0 and the point α1 are modulation amounts Vd and Ve, a change amount (ΔV) of the modulation amount from the point α0 to the point α1 may be expressed by (Ve−Vd). The control device 10 may acquire the movement amount corresponding to the sliding operation on the touch device 2 from the size of the predetermined circular area N AREA, and may acquire the change amount of the modulation amount per unit movement amount (ΔY/ΔX). The control device 10 may increase or decrease the modulation amount of the amplitude modulation from the modulation amount Vd to the modulation amount Ve according to the change rate of the modulation amount per unit movement amount (ΔY/ΔX).

In a case where the sliding operation performed on the touch device 2 reaches the point α1 on the display image A2, the control device 10 repeats the above-described control on the tactile sensation control range (circular area N+1 AREA) using the point α1 as the center.

That is, the control device 10 specifies the movement direction from the coordinate change of the touch position of the sliding operation which is continuously performed after the sliding operation reaches the point α1. The control device 10 specifies positional information of the point α2 present in the movement direction at the edge of the circular area N+1 AREA from the movement direction from the point α1 and the tactile sensation control range using the point α1 as the center. The control device 10 acquires the elevation difference (ΔH) between the point α1 and the point α2 specified from the movement direction, and repeats control for applying the above-described tactile sensation based on the elevation difference.

In the control system 1 in which the display image A2 shown in FIG. 6 is displayed, the tactile sensation control based on the elevation of the point present on the route of the sliding operation according to the control parameter stored in the tactile sensation MAP DB 201 is provided. In the control system 1, the tactile sensation applied to the fingertip of the user that performs the sliding operation on the touch device 2 is changed based on the contents and characteristics indicated by the display image A2 displayed in the display area of the display device 3. In the control system 1, it is possible to recognize the form such as the height or undulation of the ground surface on the movement route in the sliding direction on the display image A2 through the tactile sensation.

### Control Example 2

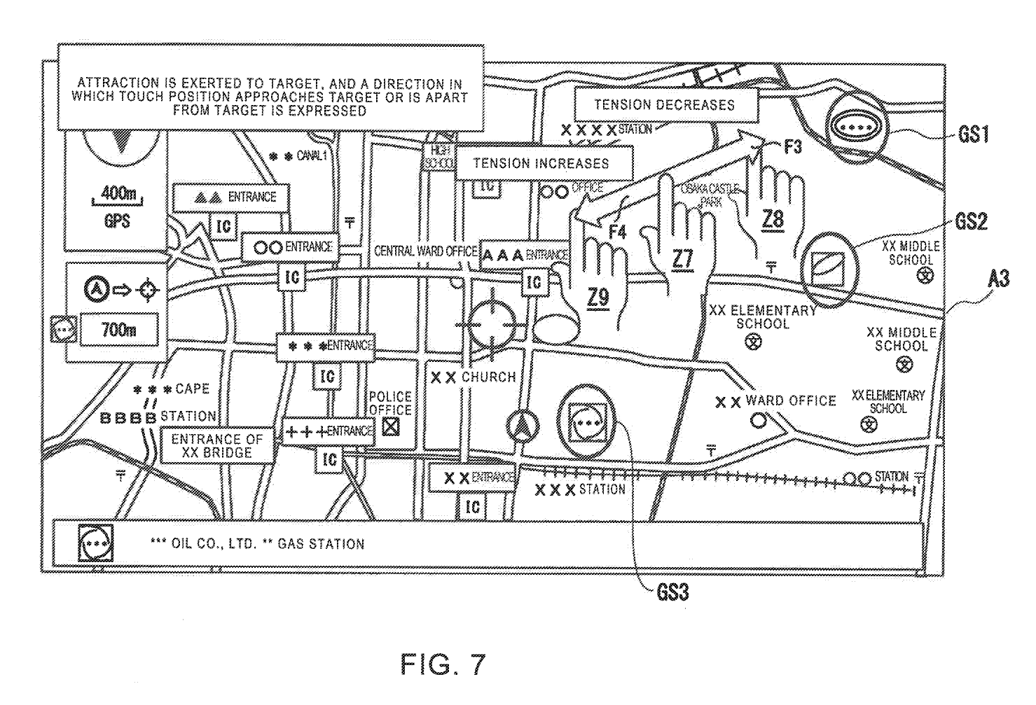

FIG. 7 is an example of another display image in a case where the tactile sensation control according to the present embodiment is performed. For example a display image A3 of FIG. 7 is a map image displayed as a navigation image in the urban area on the display device 3. In a control form which the display image A3 is displayed, the control device 10 performs control such that the user recognizes whether the movement direction is a direction in which the pointer is apart from a target on the map or a direction in which the pointer approaches the target through the tactile sensation. Pointers Z7, Z8, and Z9 represented in FIG. 7 represent icons that move on the display image A3 in line with the coordinates of the operator that touches the device surface of the touch device 2.

For example, it is assumed that the user seated on the driver's seat performs the sliding operation on the touch device 2 provided at the center console 5 in a state in which the display image A3 shown in FIG. 7 is displayed on the display device 3 provided at the dashboard 4 or the head-up display 8. For example, it is assumed that the user designates a gas station GS1 as the target on the map in a state in which the display image A3 is displayed. For example, the target on the map is designated by using a voice recognition function mounted in the AVN machine.

For example, the user touches the device surface of the touch device 2 with their fingertip in order to check the route to the gas station GS1, and moves the icon displayed so as to be superimposed on the display image A3 through the blind operation. The icon displayed so as to be superimposed on the display image A3 moves to a position direction indicated by the pointer Z8 from a position indicated by the pointer Z7 or to a position direction indicated by the pointer Z9 from the position indicated by the pointer Z7 in line with the sliding operation of the user.

In FIG. 7, it is assumed that the position indicated by the pointer Z7 is a start position of the sliding operation performed on the touch device 2. For example, the control device 10 acquires display information for the display image A3 through the AVN machine, and extracts the position indicated by the pointer Z7 and positional information (longitude or latitude) of the gas station GS1 from the display information.

The control device 10 refers to the tactile sensation MAP DB 201, and acquires the modulation pattern associated with the display information. Control parameters such as a target content (elevation difference) for changing the modulation amount of the amplitude modulation, modulation amounts acquired by dividing the modulation amount into a plurality of levels, and a tactile sensation control range using the target as a center (circular area N AREA) are included in the modulation pattern according to the present form. The control device 10 temporarily stores the positional information of the position indicated by the pointer Z7, the positional information of the gas station GS1, and the modulation pattern acquired from the tactile sensation MAP DB 201 in association with each other in the predetermined area of the main storage device 12.

The control device 10 acquires a relative distance (hereinafter, referred to as a “distance R0”) at the start position of the sliding operation from the position indicated by the pointer Z7 and the positional information of the gas station GS1. As described with reference to FIG. 5, the control device 10 specifies the movement direction corresponding to the sliding operation from the coordinate change of the touch position received at predetermined periodic intervals. The control device 10 specifies positional information of the point (corresponding to the point α1 of FIG. 5) present in the movement direction present at the edge of the circular area N AREA from the movement direction of the sliding operation and the tactile sensation control range using the point (corresponding to the point α0 of FIG. 5) indicated by the pointer Z7 as the center. The control device 10 acquires a relative distance (hereinafter, also referred to as a “distance R1”) between the point present in the movement direction at the edge of the circular area N AREA and the gas station GS1.

For example, in a case where a distance difference (ΔR=R0−R1) between the distance R0 and the distance R1 exceeds 0, the control device 10 decreases the resistance applied to the fingertip by decreasing the modulation amount according to the distance different, and performs the tactile sensation control for applying the smooth sensation (direction of arrow F3). Meanwhile, for example, in a case where the distance difference (SR) is less than 0, the control device 10 increases the modulation amount according to the distance difference, and performs the tactile sensation control for increasing the resistance (rough sensation) applied to the fingertip (direction of arrow F4). The control device 10 may perform the tactile sensation control described with reference to FIG. 5 based on the distance difference.

For example, the control device 10 may perform the tactile sensation control based on the positions (for example, the positions indicated by the pointers Z8 and Z9) on the map in the end position of the predetermined sampling period in a case where the movement direction is detected. For example, the control device 10 may gradually increase or decrease the modulation amount of the amplitude modulation according to the relative distances between the positions indicated by the pointers Z8 and Z9 for a period during which the sliding operation is performed and the gas station GS1 which is the target.

For example, it is assumed that the change rate of the modulation amount per unit movement amount is determined as the control parameter. The control device 10 increases or decreases the modulation amount based on the charge rate, and performs the amplitude modulation corresponding to the relative distance between the point indicated by the pointer Z7 and the gas station GS1 which is the target. The control device 10 may sequentially calculate the relative distances between the positions indicated by the pointers Z8 and Z9 for a period during which the sliding operation is continuously performed and the gas station GS1 which is the target according to the movement direction, and may perform control such that the modulation amount increases or decreases based on the change rate.

In all the above-described control forms, the control device 10 may apply the tactile sensation for decreasing the tension (resistance) to the fingertip in a case where the pointer moves in the direction in which the pointer approaches the target from the start position of the sliding operation. Similarly, the control device 10 may apply the tactile sensation for increasing the tension (resistance) to the fingertip in a case where the pointer moves in the direction in which the pointer is apart from the target from the start position of the sliding operation. The control device 10 may allow the user to recognize whether the movement direction is the direction in which the pointer is apart from the target on the map or the direction in which the pointer approaches the target based on the relative distance between the target represented on the display image A3 and a point through which the pointer passes during the sliding operation or the distance change from a time when the sliding operation is started through the tactile sensation.

### Control Example 3

In FIG. 7, it is assumed that gas stations GS1, GS2, and GS3 are designated as the targets on the map. For example, in the tactile sensation control form in this case, a tactile sensation control range (circular area N AREA) using each gas station as a center. For example, the control device 10 performs the tactile sensation control according to the relative distance from each gas station in a case where the position. on the map indicated by the pointer Z7 is outside the tactile sensation control range using each gas station as the center. Meanwhile, the control device 10 performs the tactile sensation control range corresponding to the relative distance by prioritizing the gas station used as the center of the tactile sensation control range in a case where the position on the map indicated by the pointer Z7 is within the tactile sensation control range using any gas station as the center.

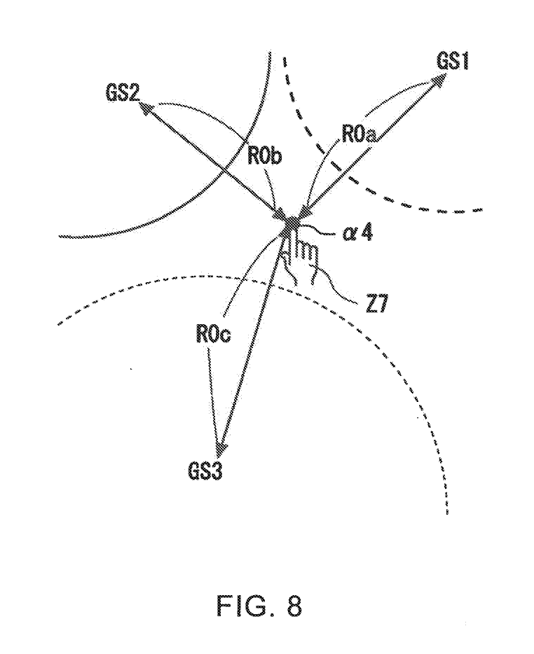

FIG. 8 is a diagram for describing the tactile sensation control in a case where a plurality of targets is present. GS1, GS2, and GS3 of FIG. 8 represent the gas stations GS1, GS2, and GS3 shown in FIG. 7. In FIG. 8, the tactile sensation control range of the gas station GS1 is expressed by a dashed-line arc, the tactile sensation control range of the gas station GS2 is expressed by a solid-line arc, and the tactile sensation control range of the gas station GS3 is expressed by a thin-dashed-line arc. A point α4 represents a point on the map indicated by the pointer Z7.

The control device 10 acquires relative distances between the point α4 indicated by the pointer Z7 and the gas stations. As shown in FIG. 8, the relative distance between the point α4 and the gas station GS1 is expressed by a distance R0a, the relative distance between the point α4 and the gas station GS2 is expressed by a distance R0b, and the relative distance between the point α4 and the gas station GS3 is expressed by a distance R0c. The control device 10 calculates a distance parameter SR for performing the amplitude modulation at the point α4 from the relative distances between the point α4 and the gas stations. For example, the distance parameter SR is expressed by ((R0a+R0a+R0c)/3).

For example, the control device 10 specifies the modulation amount at the point α4 outside the tactile sensation control ranges using the gas stations as the centers based on the calculated distance parameter SR and the change rate of the modulation amount per unit movement amount, and performs the amplitude modulation. In a case where the positions (pointers Z8 and Z9 in FIG. 6) indicated by the pointer Z7 during the movement through the sliding operation are outside the tactile sensation control ranges using the gas stations as the centers, the control device 10 repeats the same process. That is, the control device 10 calculates the distance parameter SR in the position of the moved pointer Z7. The control device 10 acquires the modulation amount corresponding to the distance parameter SR of the moved pointer position based on the change rate of the modulation amount per unit movement amount, and performs the amplitude modulation. As stated above, in a case where the indication position of which the movement is changed through the sliding operation is continuously present outside the tactile sensation control ranges using the targets as the centers, the tactile sensation control for increasing or decreasing the modulation amount based on the relative distance (distance parameter SR) between the plurality of targets is provided.

Meanwhile, in a case where the position indicated by the pointer Z7 for a period during which the sliding operation is continuously performed is within the tactile sensation control range using any gas station as the center, the control device 10 sets the gas station used as the center of the tactile sensation control range as a target of the tactile sensation control based on the relative distance. For example, in FIG. 8, in a case where the position indicated by the pointer Z7 for a period during which the pointer moves through the sliding operation moves into the tactile sensation control range represented by the solid-line arc, the control device 10 sets the gas station GS2 as the target of the tactile sensation control based on the relative distance.

The tactile sensation control described with reference to FIG. 7 is continuously provided to the fingertip that moves into the tactile sensation control range using the gas station GS2 as the center. For example, the control device 10 sequentially calculates the relative distances between the positions indicated by the pointer Z7 for a period during which the pointer moves through the sliding operation and the gas station GS2 which is the target, and performs control such that the modulation amount gradually increases or decreases according to the calculated relative distances. Alternatively, the control device 10 specifies the modulation amount corresponding to the calculated relative distance based on a predetermined change rate, and performs control such that the modulation amount increases or decreases.

The tactile sensation for decreasing the tension (resistance) may be applied to the fingertip that slides into the tactile sensation control range using the gas station GS2 as the center in a case where the fingertip moves in the direction in which the fingertip approaches the gas station GS2, or the tactile sensation for increasing the tension (resistance) may be applied to the fingertip in a case where the fingertip moves in the direction in which the fingertip is apart from the gas station GS2.

In the control form described with reference to FIG. 8, the control device 10 may provide the tactile sensation as if the fingertip is drawn into one target of the plurality of targets displayed on the display image to the fingertip of the user that performs the sliding operation.

In the control form described with reference to FIG. 8, weighting may be applied to the tactile sensation control ranges to be set to the targets. For example, in a case where the target is the gas station, information incentive to the user such as the price of various fuels (gasoline, light oil, and kerosene) sold in the gas station or the price of a car wash service is used as information for applying weighting.

For example, the control device 10 may acquire the information incentive to the user in a case where the display information regarding the display image is acquired, and may apply weighting to the tactile sensation control ranges to be set to the gas stations based on the acquired information.

For example, the size of the tactile sensation control range is changed as the form of the weighting of the tactile sensation control range. For example, it is assumed that the selling prices of the gasoline provided by the gas stations shown in FIG. 8 are low prices in order of the gas stations GS3, GS2, and GS1. The control device 10 may change the relative sizes by increasing the tactile sensation control ranges in order of the low prices of the selling prices of the gasoline, and may set the sizes of the gas stations in order of the gas stations GS3, GS2, and GS1. The control device 10 may perform the tactile sensation control using the gas station GS3 of which the selling price of the gasoline is the lowest as a preferential target.

For example, the change rate of the modulation amount per unit movement amount is changed as another form of the weighting of the tactile sensation control range. For example, the control device 10 may maximize the relative change rate with respect to the direction of the gas station GS3 of which the selling price is the lowest. The control device 10 may apply the tactile sensation for guiding the driver to the direction of the gas station GS3 of which the selling price is the lowest among the plurality of gas stations displayed on the display image to the fingertip by increasing the change rate of the modulation amount per unit movement amount with respect to the direction of the gas station GS3.

### 4. Process Flow

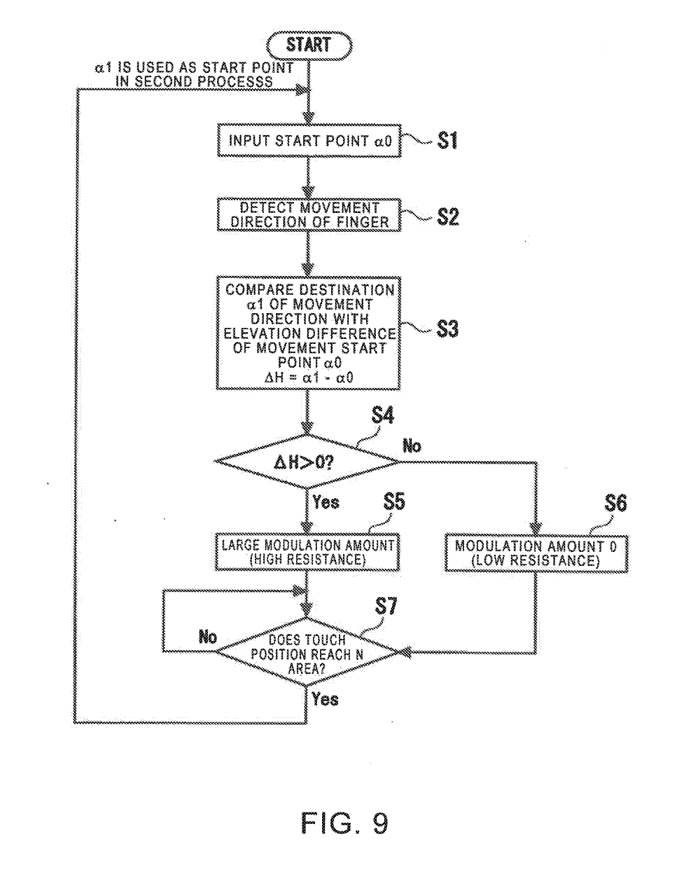

Hereinafter, a tactile sensation control process according to the present embodiment will be described with reference to FIG. 9. FIG. 9 is a flowchart showing an example of the tactile sensation control process provided by the control device 10. The process of FIG. 9 corresponds to the tactile sensation control process described with reference to FIGS. 5 and 6. The CPU 11 of the control device 10 reads and executes various programs or various data items stored in the auxiliary storage device 13, and the tactile sensation control process shown in FIG. 9 is provided. The CPU 11 of the control device 10 refers to the tactile sensation MAP DB 201 of the auxiliary storage device 13 or performs the tactile sensation control process as the storage destination of the data to be managed.

In the flowchart of FIG. 9, the process is started in a case where the touch operation for the touch device 2 of the control system 1 is performed (START). The control device 10 of the control system 1 receives the coordinates of the touch position detected through the touch device 2 at predetermined periodic intervals of 10 ms. The control device 10 temporarily stores the received coordinates of the touch position in the predetermined area of the main storage device 12.

The control device 10 acquires positional information of a point of the display image displayed in the display area of the display device 3, which corresponds to the coordinates of the touch position of the touch device 2, as a start point input (α0) (S1). The control device 10 refers to the tactile sensation MAP DB 201, and acquires the modulation pattern associated with the display information indicated by the display image. Control parameters such as a target content (elevation difference) for changing the modulation amount of the amplitude modulation, modulation amounts acquired by dividing the modulation amount into a plurality of levels, and a tactile sensation control range (circular area N AREA) are included in the modulation pattern. The control device 10 temporarily stores the positional information input as the start point input (α0) in association with the modulation pattern acquired from the tactile sensation MAP DB 201 in the predetermined area of the main storage device 12.

The control device 10 detects a movement direction corresponding to the sliding operation from the coordinate change of the touch position received at predetermined periodic intervals (S2). For example, the control device 10 determines a sampling period in a case where the movement direction is detected in advance, and specifies the movement direction corresponding to the sliding operation from a coordinate change (ΔY/ΔX) between a start position and an end position of the sampling period on the touch device 2. A pointer that moves on the display image in line with the coordinates of the fingertip which touches the device surface of the touch device 2 is displayed on the display device 3.

In the process of S3, the control device 10 specifies positional information of a point α1 of a destination of the movement direction present at an edge of the circular area ARERA shown in FIG. 6 from the movement direction of the sliding operation detected in the process of S2 and the tactile sensation control range using the movement start point α0 acquired in the process of S1 as a center. The control device 10 acquires an elevation difference (ΔH) between the point α1 and the movement start point α0 from the display information indicated by the display image. The acquired elevation difference (ΔH) is temporarily stored in the predetermined area of the main storage device 12.

In the process of S4, the control device 10 determines whether or not the elevation difference (ΔH) acquired in the process of S3 exceeds “0”. The control device 10 proceeds to the process of S5 in a case where the elevation difference (ΔH) exceeds “0” (S4, Yes). Meanwhile, the control device 10 proceeds to the process of S6 in a case where the elevation difference (ΔH) does not exceed “0” (S4, No).

In the process of S5, the control device 10 performs the tactile sensation control for increasing the resistance (rough sensation) applied to the fingertip by increasing the modulation amount according to the elevation difference (ΔH). For example, in a case where a modulation amount at the movement start point α0 is Vd and a modulation amount at the point α1 is Ve, a change amount (ΔV) of the modulation amount from the point α0 to the point α1 is (Ve−Vd). The control device 10 acquires the movement amount corresponding to the sliding operation on the touch device 2 to the point α1 from the size of the predetermined circular area N AREA, and acquires a change rate of the modulation amount pet unit movement amount (ΔY/ΔX) from the movement amount and the change amount (ΔV). The control device 10 increases the modulation amount of the tactile sensation applied to the fingertip from the modulation amount Vd to the modulation amount Ve based on the change rate of the modulation amount per unit movement amount (ΔY/ΔX) and the movement amount of the sliding operation.

In the process of S6, the control device 10 decreases the resistance applied to the fingertip by setting the modulation amount to be “0” irrespective of the elevation difference (ΔH), and performs the tactile sensation control for applying the smooth sensation. In the process of S6, the control device 10 may decrease the modulation amount according to the elevation difference (ΔH).

For example, in a case where a modulation amount at the movement start point α0 is Vd and a modulation amount at the point α1 is Vf, a change amount (ΔV) of the modulation amount from the point α0 to the point α1 is (Vf−Vd). The control device 10 acquires the movement amount corresponding to the sliding operation on the touch device 2 to the point α1 from the size of the predetermined circular area N AREA, and acquires a change rate of the modulation amount per a unit movement amount (ΔY/ΔX) from the movement amount and the change amount (ΔV). The control device 10 may decrease the modulation amount of the tactile sensation applied to the fingertip from the modulation amount V to the modulation amount Vf based on the change rate of the modulation amount per unit movement amount (ΔY/ΔX) and the movement amount of the sliding operation.

In the process of S7, the control device 10 determines whether or not a touch position moved through the sliding operation reaches the point α1 at the edge of the circular area N AREA on the display screen using the movement start point α0 as the center.

In a case where the control device proceeds from the process of S5, the control device 10 repeatedly increases the modulation amount corresponding to the movement amount of the sliding operation in a case where the touch position moved through the sliding operation does not reach the point α1 at the edge of the circular area N AREA on the display screen using the movement start point α0 as the center (S7, No). Meanwhile, the control device 10 repeats the process of FIG. 9 by using the point α1 as a start point in a case where the touch position moved through the sliding operation reaches the point α1 at the edge of the circular area N AREA on the display screen using the movement start point α0 as the center (S7, Yes).

In a case where the control device proceeds from the process of S6, the control device 10 maintains the modulation amount set to be “0” in a case where the touch position moved through the sliding operation does not reach the point α1 at the edge of the circular area N AREA on the display screen using the movement start point α0 as the center (S7, No).

In a case where the control device proceeds from the process of Sb, the control device 10 may repeatedly decrease the modulation amount corresponding to the movement amount of sliding operation in the process of decreasing the modulation amount according to the elevation difference (ΔH) in a case where the touch position moved through the sliding operation does not reach the point α1 on the edge of the circular area N AREA on the display screen using the movement start point α0 as the center (S7, No). The control device 10 repeats the process of FIG. 9 by using the point α1 as the start point in a case where the touch position moved through the sliding operation reaches the point α1 at the edge of the circular area N AREA on the display screen using the movement start point α0 as the center (S7, Yes).

Through the above-described process, the control device 10 of the control system 1 according to the present embodiment can change the tactile sensation applied to the fingertip according to the contents and characteristics indicated by the destination of the movement direction of the display image displayed on the display device 3 in a case where the movement operation (sliding operation) for the touch device 2 is performed. The control device 10 may increase or decrease the modulation amount of the amplitude modulation according to the elevation difference or gradient of the destination of the movement direction based on the display information of the map image. The control device 10 may increase or decrease the modulation amount of the amplitude modulation according to the relative positional relationship between the movement direction and the target based on the display information of the map image. According to the control device 10 of the control system 1 according to the present embodiment, it is possible to provide the tactile sensation corresponding to the characteristics of the content displayed on the display device in a case where the sliding operation is performed.

### Modification Example

It has been described in FIGS. 5 to 8 that the map image provided from the AVN machine is a display image example. It is assumed that an image for a learning material using a child as a target is displayed on the display device in a case where the control system 1 constitutes a part of the information processing apparatus such as a smartphone or a PC.

For example, it is assumed that an image of a three-dimensional object of an apple is displayed as a learning material on the display device of the information processing apparatus. For example, in the control form according to the modification example, the control device 10 provides a three-dimensional shape change such as the convexity of the flesh ranging from the edge to the center of the apple displayed as the image or the concavity at a leaflet or a stein end, as the tactile sensation.

For example, the control device 10 constituting a part of the information processing apparatus acquires a modulation pattern corresponding to the apple image stored in the tactile sensation MAP DB 201. It is assumed that the modulation pattern includes three-dimensional information associated with the display position of the apple image. The control device 10 acquires a touch start position on the touch device 2 and acquires height information corresponding to an indication position (corresponding to the point α0) of the pointer displayed so as to be superimposed on the apple image. The control device 10 acquires height information of an indication position (corresponding to the point α1) indicated by the pointer on the apple image which moves in response to the sliding operation from the touch start position. The control device 10 may increase or decrease the modulation amount of the amplitude modulation for applying the tactile sensation to the fingertip based on a difference value between the height information items.

For example, the control device 10 increases the modulation amount of the amplitude modulation for applying the tactile sensation to the fingertip and performs the tactile sensation control for increasing the resistance (rough sensation) applied to the fingertip in a case where the height of the indication position indicated by the pointer that moves on the apple image in response to the sliding operation is greater than the height of the touch start position. Similarly, the control device 10 decreases the resistance applied to the fingertip by decreasing the modulation amount of the amplitude modulation for applying the tactile sensation to the fingertip and performs the tactile sensation control for applying the smooth sensation in a case where the height of the indication position indicated by the pointer that moves on the apple image in response to the sliding operation is less than the height of the touch start position.

In the control form according to the modification example, the control device 10 may change the tactile sensation applied to the fingertip according to the contents and characteristics indicated by the image information of the three-dimensional object as the destination of the movement direction of the sliding operation. The control device 10 may provide a three-dimensional shape change of the display image displayed as the tactile sensation on the display device 3 to the user who operates the touch device 2.

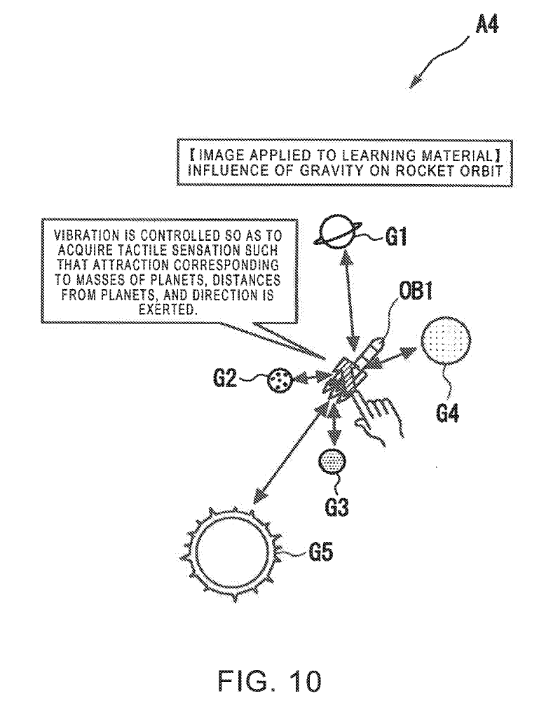

A display image of a rocket orbit that moves in an outer space of FIG. 10 is illustrated as an image for another learning material. On a display image A4 shown in FIG. 10, a plurality of planets G1 to G4 and a fixed star G5 are arranged on the image. A rocket OB1 on which the movement operation is able to be performed in the outer space in which the plurality of planets G1 to G4 and the fixed star G5 are arranged is disposed on the display image A4. A user who uses the display image A4 as the learning material performs the sliding operation on the rocket OB1, and moves the rocket in the space in which the plurality of planets G1 to G4 and the fixed star G5 are disposed. For example, in the control form according to the modification example corresponding to FIG. 10, the influence of gravity exerted on the rocket OB1 that moves in the outer space from the planets and the fixed star is provided as the tactile sensation.

For example, the control device 10 constituting a part of the information processing apparatus acquires the modulation pattern corresponding to the display image A4 stored in the tactile sensation MAP DB 201. The modulation pattern includes an arrangement position of the planets G1 to G4 and the fixed star G5 on the display image A4 and information (control parameter) for simulating the gravity of the masses of the planets G1 to G4 and the fixed star G5.

For example, the control device 10 sets the sizes of: the tactile sensation control ranges (circular areas N AREA) on the display image by using mass ratios of the planets G1 to G4 and the fixed star G5 as centers based on the mass ratios. The control device 10 performs the tactile sensation control corresponding to a distance from any one of the planets G1 to G4 or the fixed star G5 as the center within each tactile sensation control range. It is assumed that the control device 10 performs the tactile sensation control along with the movement of the sliding operation with a predetermined modulation amount Vg beyond each tactile sensation control range.

The tactile sensation control within the tactile sensation control range by using the fixed star G5, as an example, will be described. The control device 10 acquires a movement amount corresponding to the sliding operation on the touch device 2 from the size of a predetermined circular area. N AREA by using the fixed star G5 as the center. The control device 10 specifies a change rate of a modulation amount per unit movement amount (ΔY/ΔX) in a case where the rocket OB1 moves in a direction in which the rocket approaches the fixed start G5 by using a modulation amount in a case where the rocket moves to the fixed star G5 from the edge of the circular area N AREA as Vg. The control device 10 decreases the modulation amount of the amplitude modulation from the modulation amount Vg to the modulation amount 0 according to the change rate of the modulation amount per unit movement amount (ΔY/ΔX) and the distance between the rocket OB1 and the fixed star G5 in a case where the rocket OB1 moves in the direction in which the rocket approaches the fixed star G5.

Similarly, the control device 10 specifies a change rate of a modulation amount per unit movement amount (ΔY/ΔX) in a case where the rocket OB1 moves in a direction in which the rocket is apart from the fixed star G5 by using a modulation amount in a case where the rocket moves to the edge of the circular area N AREA from the fixed star G5 as a maximum modulation amount Vmax. The control device 10 decreases the modulation amount of the amplitude modulation from the maximum modulation amount Vmax to the modulation amount Vg according to the change rate of the modulation amount per unit movement amount (ΔY/ΔX) and the distance between the rocket OB1 and the fixed star G5 in a case where the rocket OB1 moves in the direction in which the rocket is apart from the fixed star G5.

In a case where the rocket moves in the direction in which the rocket approaches the fixed star G5 from the edge of the circular area N AREA. within the tactile sensation control range using the fixed star G5 as the center, since the smooth sensation is applied by decreasing the resistance applied to the fingertip, the control device 10 may provide a tactile sensation as if the rocket is attracted to the fixed star G5. Meanwhile, in a case where the rocket moves in the direction in which the rocket is apart from the fixed star G5, since the resistance (rough sensation) applied to the fingertip becomes higher as the distance between the fixed star G5 and the rocket OB1 becomes less, the control device 10 may provide the tactile sensation as if the rocket resists the attraction of the fixed star G5. In the control form according to the modification example corresponding to the display image A4 shown in FIG. 10, it is possible to provide the influence of gravity exerted according to the movement direction of the sliding operation, as the tactile sensation.

### Another Modification Example

For example, the control device 10 may change the modulation amount of the amplitude modulation applied to the fingertip that touches the front surface of the touch device 2 according to the display size, priority, or importance of the image as the target of the tactile sensation control which is displayed in the display area of the display device 3.

For example, it is assumed that a plurality of menu icons having different display sizes is displayed in a row in the display area of the display device 3. For example, the control device 10 according to the modification example compares areas (the number of pixels) of the menu icons displayed in the display area of the display device 3, and performs the tactile sensation control such that another menu icon is drawn into a menu icon having a relatively large display size. Since an icon having a high frequency of use is designed so as to be larger, convenience is improved by applying the tactile sensation such that another icon is easily sucked into an icon having a high frequency of use in the control device 10 according to the modification example.

In a case where information having a high frequency of use is preferentially disposed in the display area of the display device 3 at a higher rank like a display list of search results, the control device 10 according to the modification example performs the tactile sensation control such that another information item is drawn into the higher-rank information, for example. In the control device 10 according to the modification example, convenience is improved by applying the tactile sensation such that another information items is easily sucked with respect to an information item having a high priority.

For example, it is assumed that an icon on a map of which importance is changed according to a traveling situation is displayed in the display area of the display device 3. For example, the importance of an icon of a gasoline stand on the map is greater than that. of another icon in a case where the amount of gasoline is less than a predetermined value during traveling. The importance of an icon of a food store or a supermarket is greater than that of another icon immediately before lunch time or immediately before dinner time. In such a case, for example, the control device 10 according to the modification example performs the tactile sensation control such that another icon is drawn into an icon having high importance according to the situation. In the control device 10 according to the modification example, convenience is improved by applying the tactile sensation such that another icon is easily sucked with respect to a candidate icon having high importance changed according to rapid destination setting.

While the invention has been shown and described in detail, the foregoing description is in all aspects illustrative and not restrictive. it is therefore understood that numerous other modifications and variations can be devised without departing from the scope of the invention.

What is claimed is:

1. A control device that controls a display having a touch screen, the control device comprising:
a detector that detects a touch on the touch screen; and
a vibration controller that generates vibration of the touch screen according to the detected touch,
wherein the vibration controller changes the vibration according to a position of the detected touch and a movement direction of a sliding operation of the touch on the touch screen.

2. The control device according to claim 1,
wherein the vibration controller performs vibration change control for changing a degree of modulation of the vibration to a second state different from a first state according to the movement direction of the sliding operation.

3. The control device according to claim 1,
wherein, in a case where the movement direction of the sliding operation is performed on a map image displayed with the touch screen, and the movement direction is changed, the vibration controller performs vibration change control for changing the vibration so as to have an amplitude based on a terrain gradient of a destination of the movement direction.

4. The control device according to claim 1,
wherein, in a case where the movement direction of the sliding operation is performed on a map image displayed with the touch screen, and the movement direction is changed, the vibration controller performs vibration change control for changing the vibration to have an amplitude corresponding to an attribute of a target located at a destination of the movement direction.

5. The control device according to claim 1,
wherein, in a case where the movement direction of the sliding operation is performed on an image of a three-dimensional object displayed with the touch screen, and the movement direction is changed, the vibration controller performs vibration change control for changing the vibration to have an amplitude corresponding to convexity or concavity of the three-dimensional object.

6. The control device according to claim 1,
wherein, in a case where the movement direction of the sliding operation is performed on a display image of a plurality of targets displayed with the touch screen, and the movement direction is changed, the vibration controller performs vibration change control for changing the vibration so as to have an amplitude corresponding to any of a size, a priority, or an importance of a target at a destination of the movement direction.

7. A control method of controlling a display having a touch screen, the method comprising the steps of:
(a) detecting a touch on the touch screen; and
(b) generating vibration of the touch screen according to the detected touch,
wherein, in the step (b), the vibration is changed according to a position of the detected touch and a movement direction of a sliding operation the touch on the touch screen.
